(19) United States
(12) Patent Application Publication
(10) Pub. No.: US 2014/0000429 A1
(43) Pub. Date: Jan. 2, 2014

(54) CUTTING APPARATUS AND COMPUTER READABLE MEDIUM

(71) Applicants: Shinya Fujihara, Obu-shi (JP); Masahiko Nagai, Nagoya-shi (JP)

(72) Inventors: Shinya Fujihara, Obu-shi (JP); Masahiko Nagai, Nagoya-shi (JP)

(73) Assignee: BROTHER KOGYO KABUSHIKI KAISHA, Nagoya-shi (JP)

(21) Appl. No.: 13/928,605

(22) Filed: Jun. 27, 2013

(30) Foreign Application Priority Data
Jun. 28, 2012 (JP) 2012-145410

(51) Int. Cl. B26D 5/00

(52) U.S. Cl. CPC B26D 5/005
USPC 83/76.6

(57) ABSTRACT

A cutting apparatus comprises a cutter holder configured to receive a cutter, a transfer mechanism configured to transfer an object to a first direction. The cutting apparatus further comprises a cutter moving mechanism configured to move the cutter holder to a second direction, and the first direction and the second direction are relative to each other. The cutting apparatus further comprises a pressure control mechanism configured to change a pressure of the cutter holder to the object, based on a pressure value for pressing the cutter holder. The cutting apparatus further comprises a processor and a memory. The memory is configured to store computer-readable instructions, when executed by the processor, cause the cutting apparatus to specify a specific pressure value for pressing the cutter holder by the pressure control mechanism, according to one or more of the first direction and the second direction.

### CROSS-REFERENCE TO RELATED APPLICATION

This application is based upon and claims the benefit of priority from the prior Japanese Patent Application 2012-145410, filed on, Jun. 28, 2012, the entire contents of which are incorporated herein by reference.

### BACKGROUND

Conventionally, a cutting apparatus is known. The cutting apparatus can cut a pattern from a sheet such as for a paper, automatically. The cutting apparatus can transfer an object toward front-back direction (Y-axis direction) by a transfer mechanism, and transfer a cutter head which comprises a cutter toward left-right direction (X-axis direction) along a guide axis. As a result of this movement, the cutting apparatus can cut an intended pattern from the object.

In a conventional cutting apparatus, a carriage of the cutting apparatus holds the cutter extending to a vertical direction on a front side, and the carriage is configured to be held slidably by the guide axis on a rear side. The carriage corresponds to the cutter head. A subsidiary guide plate is disposed on an upper of the guide axis, and the subsidiary guide plate is directed parallel to the guide axis. Furthermore, the carriage comprises slidable portion configured to holds the subsidiary guide plate. The slidable portion is held so as not to round on the guide axis.

When the object is transferred by the transfer mechanism to the cutter and the object is cut by the cutter, a blade edge of the cutter receives reaction force as a cutting resisting force from the object. As a result, the cutting head receives moment of surrounding of the guide axis.

### SUMMARY

More specifically, when the object is transferred from a front side to a back side, the moment directed to a direction that the cutter cuts into the object is acted. The cutter can cut the object, because the cutter can press the object sufficiently. However, the object is transferred by the transfer mechanism from a back side to a front side, the moment directed to a direction that the cutter is apart from the object is acted. A position of the blade edge of the cutter is moved to upper position slightly, because of bending of the cutter and the cutter head slightly, or a clearance between the slidable portion of the cutter head and the subsidiary guide plate. For this reason, the cutter cannot press the object sufficiently, and the object cannot be cut for certain.

Various exemplary embodiments of the general principles herein may provide a cutting apparatus comprises a cutter holder configured to receive a cutter, and a transfer mechanism configured to transfer an object to a first direction. The cutting apparatus further comprises a cutter moving mechanism configured to move the cutter holder to a second direction, and the first direction and the second direction are relative to each other. The cutting apparatus further comprises a pressure control mechanism configured to change a pressure of the cutter holder to the object, based on to pressure value for pressing the cutter holder. The cutting apparatus further comprises a processor, and a memory. The memory is configured to store computer-readable instructions which, when executed by the processor, cause the cutting apparatus to specify a specific pressure value for pressing the cutter holder by the pressure control mechanism, according to one or more of the first direction and the second direction.

Exemplary embodiments herein may provide a non-transitory computer-readable medium storing computer-readable instructions therein that, when executed by a processor of a cutting apparatus, cause the cutting apparatus to specify a specific pressure value for pressing a cutter holder of the cutting apparatus, by a pressure control mechanism configured to change a pressure of the cutter holder to an object based on the specific pressure value for pressing the cutter holder, according to one or more of a first direction to which a transfer mechanism configured to transfer the object, and a second direction to which a cutter moving mechanism configured to move the cutter holder. The cutter holder is configured to receive a cutter.

### BRIEF DESCRIPTION OF THE DRAWINGS

In the accompanying drawings:

FIG. 1 is a perspective view of a cutting plotter according to one embodiment, showing the inner structure thereof;

FIG. 2 is a plan view of the cutting plotter, showing the inner structure thereof;

FIG. 3 is a longitudinal left section taken along III-III in FIG. 2;

FIG. 4 is a perspective view of a cutter head;

FIG. 5 is a front view of the cutter head;

FIG. 6 is a plan view of the cutter head;

FIG. 7 is a longitudinal front view of the cutter head taken along line VII-VII in FIG. 6;

FIG. 8 is an enlarged view of a distal end of the cutter during cutting and the vicinity thereof;

FIG. 9 is a schematic block diagram showing an electrical arrangement of the cutting plotter;

FIG. 10A shows a data structure of cutting data of a pattern;

FIG. 10B explains the cutting data of the pattern; and

FIG. 11 is a flowchart showing the processing for pressure change of the cutter during cutting.

### DETAILED DESCRIPTION

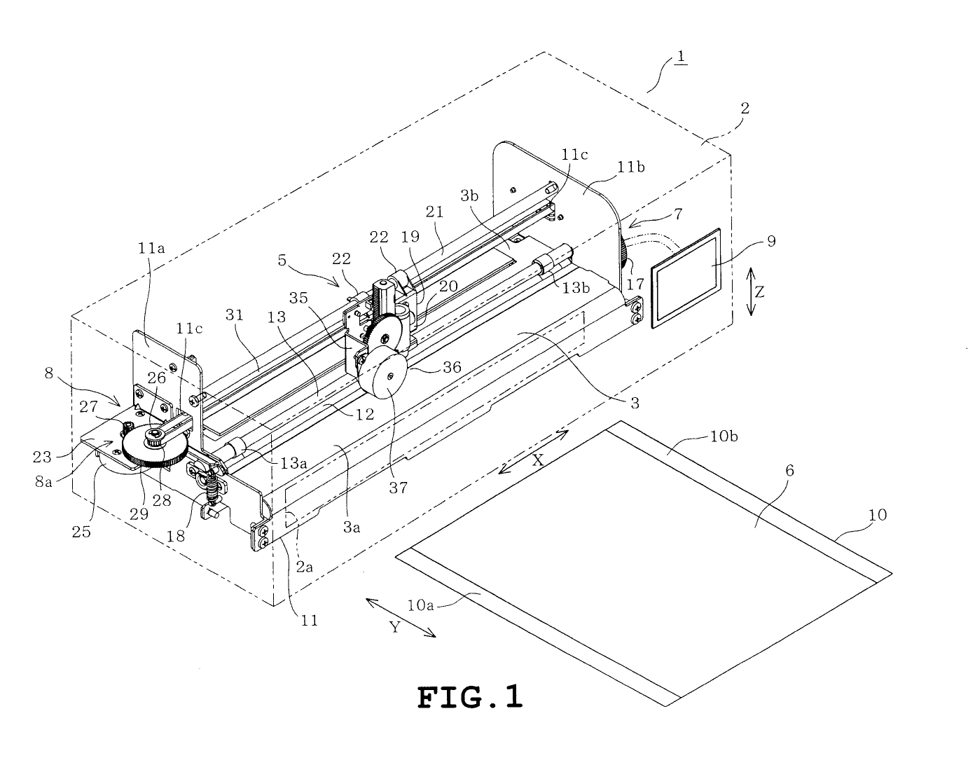

One embodiment will be described with reference to FIGS. 1 to 11. Referring to FIG. 1, a cutting plotter 1 serving as a cutting apparatus includes a body cover 2 as a housing, a platen 3 enclosed in the body cover 2 and a cutting head 5 having a cutter 4 (see FIG. 7). The body cover 2 is formed into the shape of a horizontally long rectangular box and has a front formed with a horizontally long insertion hole 2a. An object 6 to be cut is inserted into the insertion hole 2a while being held on a holding sheet 10, thereby being set onto the platen 3. The object 6 is a sheet of paper, for example.

The cutting plotter 1 includes a transfer mechanism 7 which transfers the object 6 in a predetermined transfer direction. The cutting plotter 1 also includes a cutter moving mechanism 8 which moves the cutting head 5 in a direction intersecting the transfer direction of the object 6 (a direction perpendicular to the transfer direction, for example). In the following description, a direction in which the cut target 6 is moved by the first transfer mechanism 7 will be referred to as “front-back direction.” More specifically, the side of the cutting plotter 1 where the insertion hole 2a is located will be referred to as “front” and the opposite side will be referred to as “back.” As shown in FIG. 1, the front-back direction will be referred to as “Y direction.” The right-left direction perpendicular to the Y direction will be referred to as “X direction.” An up-down direction perpendicular to the front-back and right-left directions will be referred to as “Z direction.”

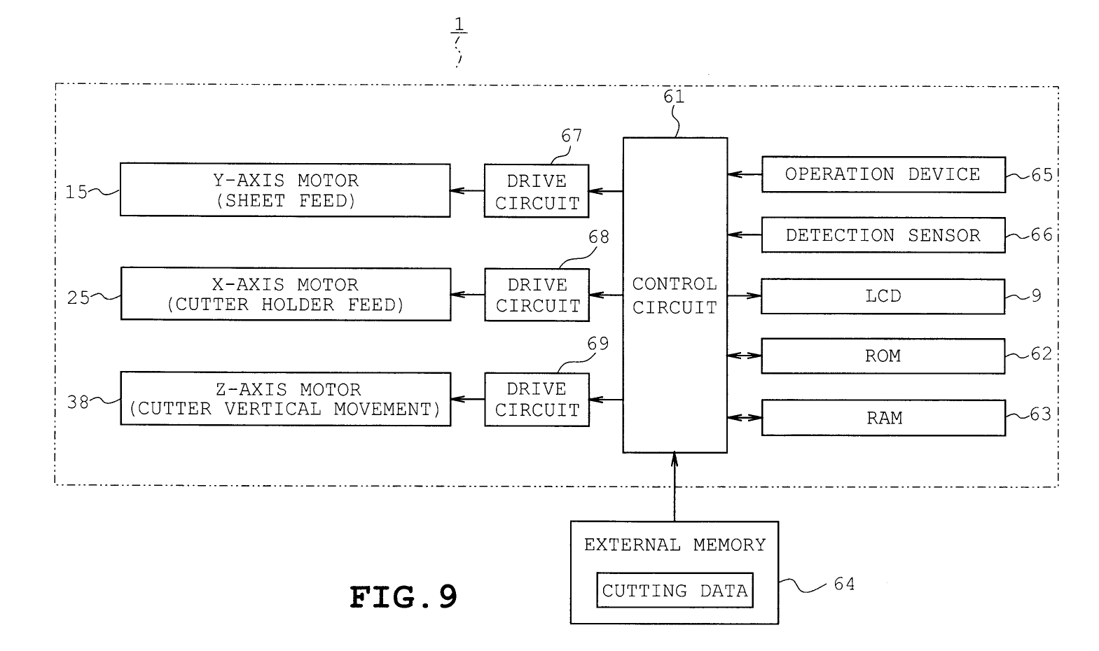

On a right part of the body cover 2 are mounted a full-color liquid crystal display (LCD) 9 and an operation device 65 including a plurality of operation switches (see FIG. 9). The LCD 9 is configured as a display unit displaying various patterns, various messages necessary for the user, and the like. The operation device 65 serves as an input unit for the user to enter various instructions, selections and inputs to the cutting plotter 1. Operation of the operation device 65 or the operation switches realizes selection of a pattern displayed on the LCD 9, set of various parameters, instruction of functions, switch of modes during cutting as will be described later, and the like.

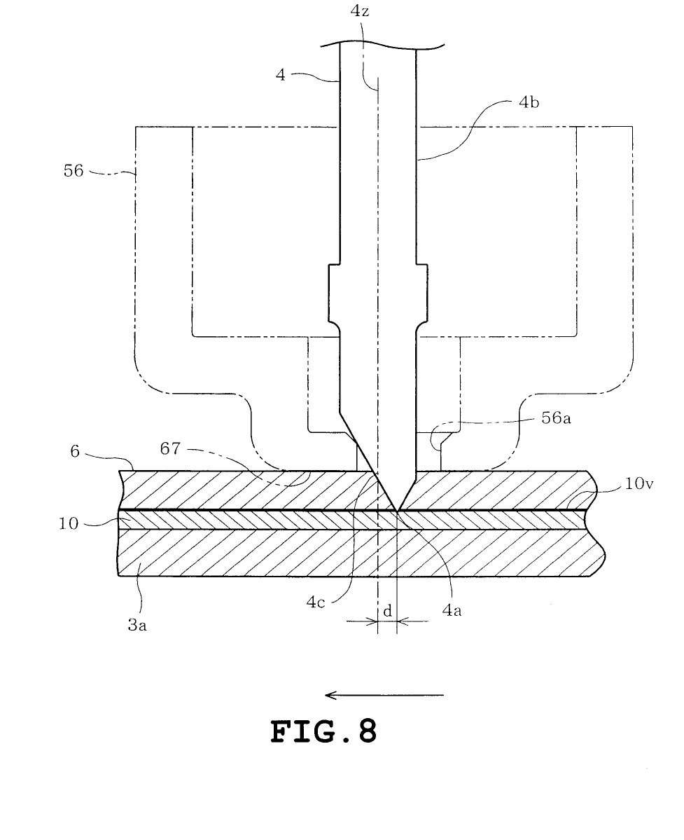

The platen 3 is configured to receive an underside of the holding sheet 10 when the object 6 is cut. The platen 3 includes a front platen 3a and a rear platen 3b and is mounted to an apparatus frame 11, as shown in FIGS. 1 to 3. The platen 3 has an upper surface which serves as a horizontal plane. The holding sheet 10 holding the object 6 is set on the platen 3 and then transferred. The holding sheet 10 is made from a synthetic resin material and formed into the shape of a rectangular sheet slightly longer in a front-back direction, as shown in FIG. 1. The holding sheet 10 has an upper surface with an adhesive layer 10v (see FIG. 8) formed by applying an adhesive agent to an inside region thereof except for right and left peripheral edges 10a and 10b. The adhesive layer 10v has adhesion set to a small value such that the object 6 can easily be removed. The user affixes the object 6 to the adhesive layer 10v, whereby the object 6 is held on the holding sheet 10.

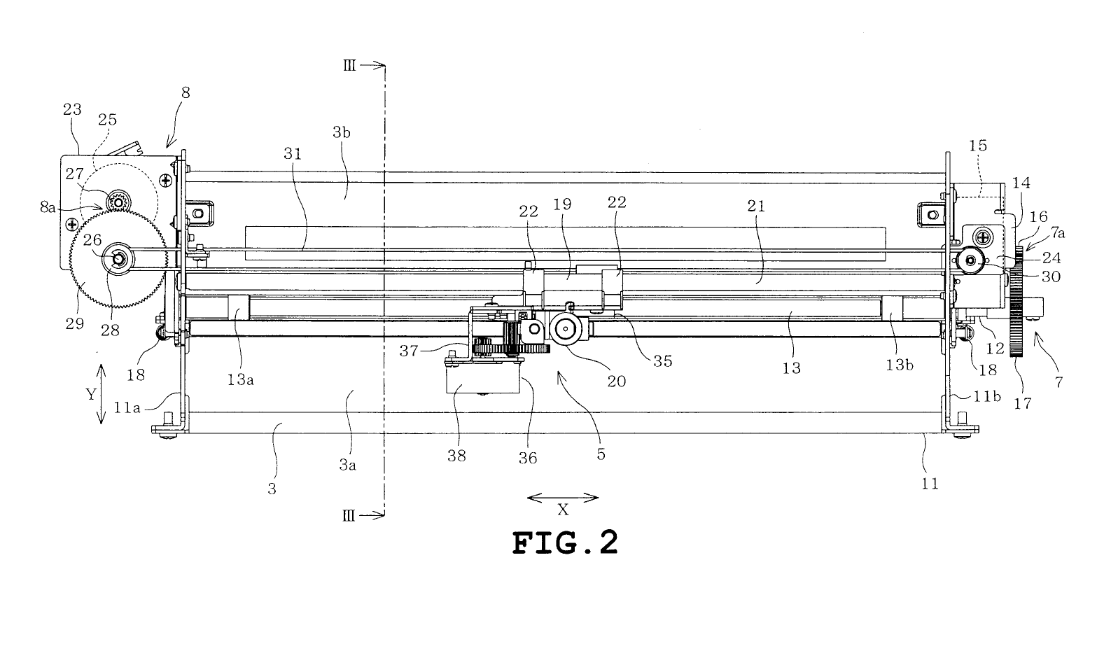

The transfer mechanism 7 and the cutter moving mechanism 8 are configured as a relative movement unit which moves the cutter 4 in the X direction and the holding sheet 10 holding the object 6 in the Y direction relative to each other. The transfer mechanism 7 transfers the holding sheet 10 at the side of the upper surface of the platen 3 freely in a predetermined transfer direction (the Y direction). More specifically, the apparatus frame 11 is provided in the body cover 2 as shown in FIGS. 1, 2 and the like. The apparatus frame 11 is provided with a sidewall 11a located at the left side of the platen 3 and a sidewall 11b located at the right side of the platen 3. The sidewalls 11a and 11b are disposed so as to face each other. A driving roller 12 and a pinch roller shaft 13 are mounted between the sidewalls 11a and 11b so as to be located in a space defined between the front and rear platens 3a and 3b, as shown in FIGS. 1 to 3. The driving roller 12 and the pinch roller shaft 13 both extend in the right-left direction and are arranged one above the other. The driving roller 12 is located under the pinch roller shaft 13.

The driving roller 12 is disposed so that an upper end thereof is substantially at the level of an upper surface of the platen 3. The driving roller 12 has right and left ends rotatably mounted on the sidewalls 11b and 11a respectively. The right end of the driving roller 12 extends through a hole (not shown) in the right sidewall 11b. A driven gear 17 having a lamer diameter is secured to a right distal end of the driving roller 12. A mounting frame 14 is mounted on the right sidewall 11b so as to be located in the rear of the right end of the driving roller 12. Y-axis motor 15 is fixed to an inner wall of the mounting frame 14. The Y-axis motor 15 is comprised of a stepping motor, for example. The Y-axis motor 15 has an output shaft to which a smaller-diameter driving gear 16 is fixed. The driving gear 16 is brought into mesh engagement with the driven gear 17.

The pinch roller shaft 13 has right and left ends which are mounted on the sidewalls 11b and 11a so as to be rotatable and displaceable slightly in the up-down direction. Thus, the pinch roller shaft 13 is displaceable in the up-down direction, that is, in a direction of thickness of the object 6. Two extension coil springs 18 extend between right and left ends of the pinch roller shaft 13 and the sidewalls 11b and 11a so as to be located outside the sidewalls 11b and 11a, respectively. Accordingly, the pinch roller shaft 13 is normally biased downward (or to the driving roller 12 side) by the extension coil springs 18. The pinch roller shaft 13 has slightly larger-diameter rollers 13b and 13a located near the right and left ends thereof respectively, as shown in FIGS. 1 and 2.

The right and left edges 10b and 10a of the holding sheet 10 are thus held between the driving roller 12 and the respective rollers 13b and 13a of the pinch roller shaft 13. Upon drive of the Y-axis motor 15, normal or reverse rotation thereof is transmitted via the gears 16 and 17 to the driving roller 12, whereby the holding sheet 10 is moved backward or forward together with the object 6. The transfer mechanism 7 is comprised of the driving roller 12, the pinch roller shaft 13, the Y-axis motor 15, the driving gear 16, the driven gear 17 and the extension coil springs 18. Furthermore, the driving gear 16 and the driven gear 17 constitute a reduction gear mechanism 7a for transfer of the object 6 by the transfer mechanism 7 (see FIG. 2).

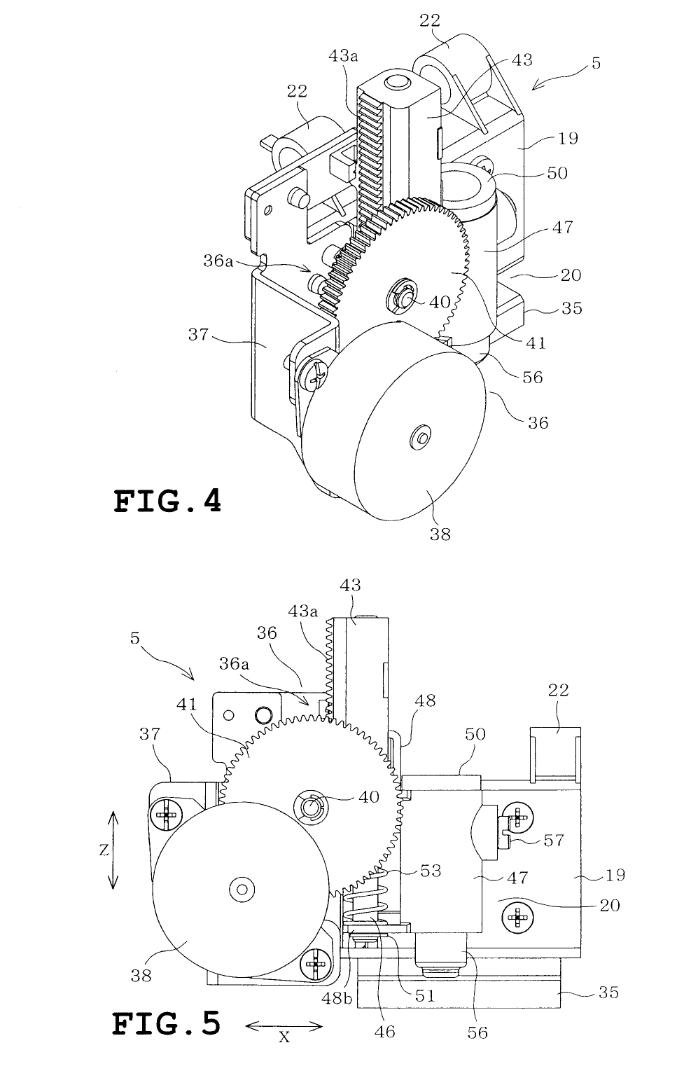

The cutter moving mechanism 8 is configured to move a carriage 19 of the cutting head 5 freely in the X direction (the right-left direction). More specifically, a guide shaft 21 is fixed between the sidewalls 11a and 11b so as to be located slightly in the rear of and above the pinch roller shaft 13, as shown in FIGS. 1 to 3. The guide shaft 21 is a round bar-like guide member, for example and extends substantially in parallel to the pinch roller shaft 13, that is, in the right-left direction. Two guide cylinders 22 are mounted at right and left locations on an upper part of the carriage 19 respectively as shown in FIG. 4 and the like. The guide shaft 21 extends through the guide cylinders 22. Thus, the carriage 19 is supported on the guide shaft 21 so as to be slidable in the right-left direction. The guide shaft 21 may not be round bar-like but may be a square tube-like or prismatic member.

A horizontal mounting plate 23 is mounted on a slightly rear outer surface of the left sidewall 11a as shown in FIGS. 1 and 2. An auxiliary mounting plate 24 is mounted on an outer surface of the right sidewall 11b. An X-axis motor 25 is mounted on the underside of the mounting plate 23 so as to be directed upward. A vertically extending pulley shaft 26 is rotatably mounted on a frontward upper surface of the mounting plate 23. The X-axis motor 25 is comprised of a stepping motor, for example and has an output shaft to which a smaller diameter driving gear 27 is fixed. A larger diameter driven gear 29 and a timing pulley 28 are rotatably mounted on the pulley shaft 26. The driven gear 29 is brought into mesh engagement with the driving gear 27. The timing pulley 28 and the driven gear 29 are formed so as to be rotated together.

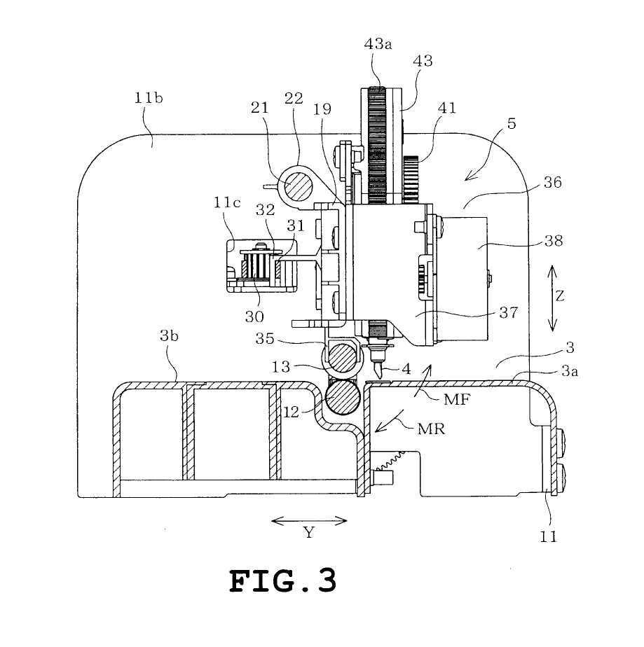

A timing pulley 30 is rotatably mounted on the auxiliary mounting plate 24 with an axis thereof being directed in the up-down direction. An endless timing belt 31 extends horizontally in the right-left direction between the timing pulleys 28 and 30. The timing belt 31 is connected at a part thereof to a mounting portion 32 (see FIG. 3 etc.) of a rear surface of the carriage 19. The sidewalls 11a and 11b have generally square through holes 11c through which the timing belt 31 passes, respectively.

Upon drive of the X-axis motor 25, normal or reverse rotation thereof is transmitted via the gears 27 and 29 and the timing pulley 28 to the timing belt 31, with the result that the carriage 19 (the cutting head 5) is moved rightward or leftward. The carriage 19 and the cutting head 5 are thus moved in the right-left direction perpendicular to the direction in which the object 6 is transferred. The cutter moving mechanism 8 is thus comprised of the guide shaft 21, the X-axis motor 25, the driving gear 27, the driven gear 29, the timing, pulleys 28 and 30, the timing belt 31. Furthermore, the driving gear 27 and the driven gear 29 constitute a reduction gear mechanism 8a related to the movement of the object 6 by the cutter moving mechanism 8.

The cutting head 5 is disposed on the front of the carriage 19 while the cutter holder 20 and an up-down drive mechanism 36 are disposed on the right and left of the cutting head 5, respectively. The cutting head 5 is configured as a support mechanism which supports the cutter 4 so that the cutter 4 is moved by the up-down drive mechanism 36 in directions such that the cutter 4 is pressed against and departs from the object 6. The configuration of the cutting head 5 will be described with reference to FIGS. 3 to 7. The carriage 19 located in the rear of the cutting head 5 is formed into a substantially rectangular plate shape slightly horizontally long as viewed from the front. The carriage 19 has an upper end provided with the right and left guide cylinders 22. The carriage 19 has a mounting portion 32 (see FIG. 3) which is formed on the rear thereof so as to protrude rearward. The mounting portion 32 is connected to the timing belt 31.

The carriage 19 has a front formed with an L-shaped first engagement portion 33 and a groove-like second engagement portion 34 in planar view. The first engagement portion 33 is located on a slightly leftward front of the carriage 19 and formed so as to extend in the up-down direction. The second engagement portion 34 is located substantially in the central front of the carriage 19 and formed so as to extend in the up-down direction. A cutter holder 20, which will be described in detail later, includes a first engaged portion and a second engaged portion both of which engage the first and second engagement portions so as to be slidingly movable in the up-down direction (the Z direction). The carriage 19 has a lower end formed with a sliding contact portion 35 for maintaining a posture of the cutter holder 20. The sliding contact portion 35 is formed into a generally downwardly directed U-shape in a side view and extends in the right-left direction. The sliding contact portion 35 has an inner surface which slidably contacts the pinch roller shaft 13. As a result, the sliding contact portion 35 functions as an anti-slippage member which prevents rotation of the guide shaft 21 while allowing movement of the carriage 19 in the X direction.

The carriage 19 includes a crank-shaped mounting plate 37 disposed on the left front thereof as shown in FIGS. 3 to 7. The mounting plate 37 serves as a mounting portion for mounting the up-down drive mechanism 36. The mounting plate 37 has a left end front on which a Z-axis motor 38 is mounted so as to be directed rearward. The Z-axis motor 38 is comprised of a stepping motor and has an output shaft to which a smaller diameter driving gear 39 is fixed. A frontwardly extending gear shaft 40 is mounted on the mounting plate 37 so as to be located rightwardly above the Z-axis motor 38. A driven gear 41 and a pinion gear 42 are secured on the gear shaft 40 so as to be rotated together. The driven gear 41 is a larger diameter gear brought into mesh engagement with the driving gear 39.

A rack member 43 extending in the up-down direction is disposed on the right of the gear 40. The rack member 43 has a left sidewall and front wall connected to each other. The rack member 43 is supported on a shaft 46 so as to be movable in the up-down direction, as will be described later. The rack member 43 has a rack 43a which is formed on the left sidewall so as to extend in the up-down direction. The pinion gear 42 is configured to be brought into mesh engagement with the rack 43a.

The rack member 43 has a pair of support pieces 44 formed integrally with each other as shown in FIG. 7. The upper support piece 44 and a middle support piece 45 are each formed into a horizontal thin-plate shape and extend rightward. The upper and middle support pieces 44 and 45 have through holes 44a and 45a respectively. A vertically elongate round bar-shaped shaft 46 is inserted through the holes 44a and 45a. The shaft 46 is disposed in the rack member 43 so as to be movable in the up-down direction.

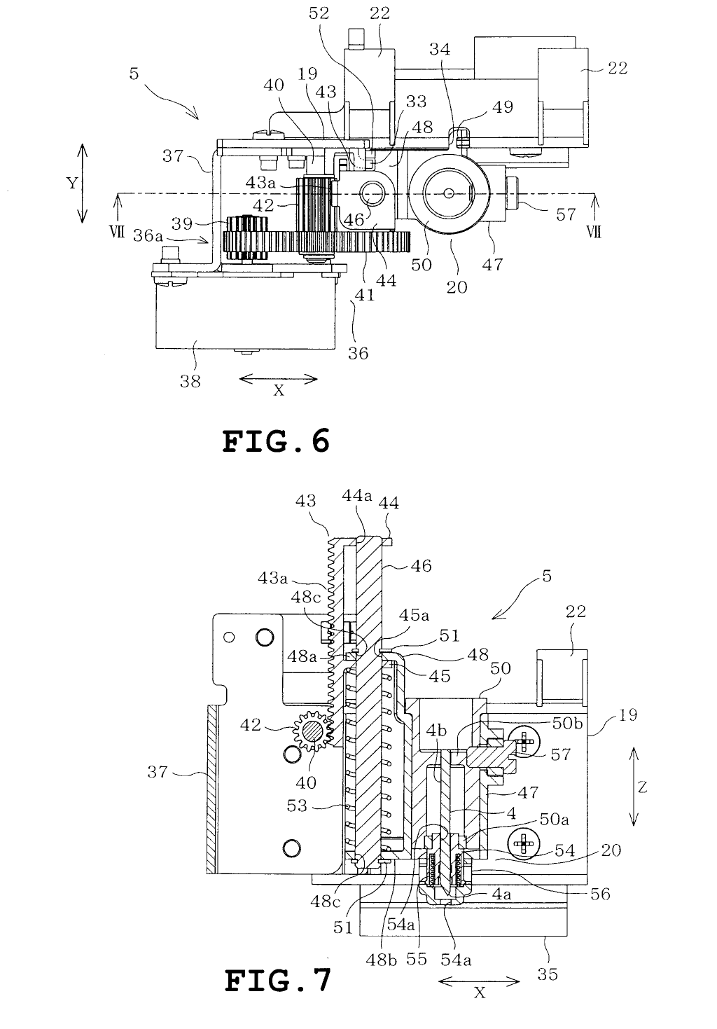

The cutter holder 20 includes a mounting cylinder 47, a shaft support 48, a first engaged portion 52 and a second engaged portion 49 (shown only in FIG. 6), all of which are formed integrally with one another. The mounting cylinder 47 is formed into a generally cylindrical shape and extends in the up-down direction. A cutter support cylinder 50 is detachably mounted to the mounting cylinder 47 as will be described later. The first engaged portion 52 is located in the rear of the shaft 46 so as to extend in the up-down direction. The first engaged portion 52 is in engagement with the first engagement portion 33 of the carriage 19 so as to be movable in the up-down direction. The second engaged portion 49 which is generally L-shaped in planar view is located on the rear side of the mounting cylinder 47 so as to extend in the up-down direction. The second engaged portion 49 is engaged with the second engagement portion 34 of the carriage 19 so as to be movable in the up-down direction. Thus, the cutter holder 20 is supported on the carriage 19 so as to be movable in the up-down direction.

The shaft support 48 is located on the left of the mounting cylinder 47. The shaft support 48 has an upper plate 48a and a lower plate 48b as shown in FIG. 7. The upper and lower plates 48a and 48b are formed with respective through circular holes 48c through which the shaft 46 is inserted. The upper plate 48a is disposed so as to overlap an upper surface of the intermediate support piece 45. Two stop rings 51 are secured to a vertically middle portion of the shaft 46 (a portion near the upper end) and a lower end of the shaft 46, whereby the shaft 46 is mounted on the shaft support 48. A compression coil spring 53 serving as a biasing member is disposed around the rack member 43 between the underside of the intermediate support piece 45 of the rack member 43 and an upper surface of the lower plate 48b.

As the result of the above-described configuration, the cutter holder 20 is moved upward or downward with upward or downward movement of the rack member 43 in the shaft support 48. More specifically, when the Z-axis motor 38 is driven, normal or reverse rotation thereof is transmitted via the driving gear 39, the driven gear 41 and the pinion gear 42 to the rack member 43, whereby the cutter holder 20 is moved upward or downward. In this case, the cutter holder 20 is moved between a lowered position where a blade edge 4a (see FIG. 8) of the cutter 4 passes through the object 6 and presses the object 6 and a raised position where the blade edge 4a departs from the object 6 by a predetermined distance. The up-down drive mechanism 36 includes the Z-axis motor 38, the gears 39, 41 and 42, the rack member 43 and the like. Furthermore, the gears 39, 41 and 42 also constitute the reduction gear mechanism 36a for upward and downward movement of the cutter 4.

The movement of the cutter holder 20 to the lowered position will now be described in detail. As the result of the up-down drive mechanism 36 having the above-described reduction gear mechanism 36a, the cutter holder 20 is gradually moved downward with downward movement of the rack member 43. In this case, the rack member 43 is moved downward together with the cutter holder 20 while the intermediate support piece 45 of the rack member 43 and the upper plate 48a of the cutter holder 20 are in contact with each other by a biasing force of the compression coil spring 53. The downward movement of the cutter holder 20 is stopped at the location where the blade edge 4a has passed through the object 6. On the other hand, only the rack member 43 is continuously moved downward. The rack member 43 is stopped after having been moved downward by a predetermined distance. More specifically, when the cutter holder 20 assumes the lowered position, the compression coil spring 53 is compressed downward by a predetermined distance by the intermediate support piece 45. Accordingly, the cutter 4 presses the object 6 by the biasing force proportional to the compressed length. On the other hand, the cutter holder 20 (the cutter 4) is allowed to move upward against the biasing force of the compressed coil spring 53 even when the object 6 is rugged in the case of the relative movement of the object 6 and the cutter 4 by the transfer mechanism 7 and the cutter moving mechanism 8

The cutter support cylinder 50 is formed into a vertically long cylindrical shape as shown in FIG. 7. The cutter support cylinder 50 has an outer circumferential surface fitted in the inner circumferential surface of the mounting cylinder 47. A bearing member 50a is fixed to a lower inner circumferential end of the cutter support cylinder 50. The cutter support cylinder 50 also has a bearing 50b formed integrally with the inner circumferential surface thereof so that the bearing 50b is located near an upper end thereof. The bearing 50b is configured to be brought into sliding contact with an outer circumferential surface of the cutter shaft 4b. The cuter 4 is supported on the bearing members 50a and 50b so as to be rotatable about a central axis 4z (see FIG. 8).

The cutter 4 has the cutter shaft 4b and a blade 4c both of which are formed integrally therewith. The cutter shaft 4b constitutes a base of the cutter 4 and is formed into a round bar shape. The blade 4c is formed on a distal end (a lower end) of the cutter shaft 4b. The blade 4c has a substantially triangular shape and is inclined relative to the object 6. The blade 4c includes a lowermost end of the blade edge 4a formed on a location decentered from a central axis line 41 by a predetermined distance d as shown in FIG. 8.

A fitting support member 54 is attached to a part of the cutter 4 located near the lower end of the cutter 4 as shown in FIG. 7. The fitting support member 54 is formed into a stepped cylindrical shape and provided with a through hole 54a axially extending through the center thereof. The cutter shaft 4b is adapted to be press fitted through the hole 54a. As a result, the fitting support member 54 is assembled to the cutter 4 so as to be integral with the cutter 4. The fitting support member 54 has an upper end fitted into the bearing member 50a. Thus, the cutter 4 is supported so as to be rotatable relative to the cutter support cylinder 50 by the bearing member 50a and the bearing portion 50b in the condition that the cutter 4 is fitted with the fitting support member 54. A pressing portion 56 is formed on a lower part of the cutter support cylinder 50 so as to be movable upward and downward. The pressing portion 56 is formed into a cylindrical cap shape and covers the circumference of the blade edge 4a. A coil spring 55 (shown only in FIG. 7) is disposed between the fitting support member 54 and the pressing portion 56. The coil spring 55 normally biases the pressing portion 56 downward. The pressing portion 56 has a central underside formed with a through hole through which the blade edge 4a is passable.

The cutter support cylinder 50 is fitted into the mourning cylinder 47 from above and fixed to the mounting member 47 by a screw 57. In this mounted state, the cutter 4 is supported on the cutter holder 20 at a location deviated forward front the guide shaft 21. The pressing portion 56 is eliminated in FIG. 3 for the sake of easiness in the explanation.

The cutter 4 is thus moved upward and downward by the up-down drive mechanism 36 while being supported by the cutter support cylinder 50. FIGS. 5 and 7 show the raised position of the cutter 4 during the normal time (non-cutting time). The blade edge 4a is covered with the pressing portion 56 during the normal time so as not to be exposed. When the cutter holder 20 is lowered by the up-down drive mechanism 36, the underside of the pressing portion 56 firstly contacts with the upper side of the object 6. This prevents further downward movement of the pressing portion 56. The cutter holder 20 is further moved downward against the spring force of the coil spring 55. As a result, the blade edge 4a passes through a hole 56a of the pressing portion 56 and then through the object 6, reaching the aforesaid lowered position. In this case, the height of the blade edge 4a is set such that the blade edge 4a passes through the object 6 placed on the holding sheet 10 but does not reach the upper side of the front platen 3a. In this state, the holding sheet 10 is freely moved in the Y direction by the transfer mechanism 7 and the cutting head 5 is freely moved in the X direction by the cutter moving mechanism 8, whereby a cutting operation is executed for the object 6.

The cutting plotter 1 is provided with a detection sensor 66 (see FIG. 9) detecting the holding sheet 10 set through the insertion hole 2a. A left corner of the set holding sheet 10 is set as an origin O (see FIG. 1) on the basis of a detection signal of the detection sensor 66. The cutting plotter 1 has a coordinate system with the origin O of the holding sheet 10 as a reference point. The holding sheet 10 (the object 6) and the cutting head 5 (the cutter 4) are moved relative to each other based on cutting data as will be described later. In the coordinate system of the cutting plotter 1, the direction in which the object 6 is moved from left to right refers to an X-axis positive direction. Furthermore, the direction in which the object 6 is moved from rear to front with respect to the object 6, that is, the direction in which the object 6 is moved rearward refers to a Y-axis positive direction.

The control system of the cutting plotter 1 will be described with reference to FIG. 9. A control circuit 61 controlling the whole cutting plotter 1 is mainly composed of a computer (CPU) serving a control unit. To the control circuit 61 are connected a ROM 62, a RAM 63 and an external memory 64. The ROM 62 stores a control program on which a cutting operation is controlled and a display control program on which the LCD 9 is controlled. The RAM 63 temporarily stores data or programs necessary for each process.

To the control circuit 61 are supplied operation signals generated by the operation switches of the operation device 65, various detection sensors including the detection sensor 66. Furthermore, the LCD 9 is also connected to the control circuit 61. A pattern selecting screen, a mode selecting screen and the like are displayed on the LCD 9. While viewing the displayed contents of the LCD 9, the user operates various switches of the operation device 65 to select a desired pattern or to set a mode in the cutting. Furthermore, drive circuits 67 to 69 driving the Y-axis motor 15, the X-axis motor 25 and the Z-axis motor 38 respectively are connected to the control circuit 61. The control circuit 61 executes a cutting control program to control the Y-axis motor 15, the X-axis motor 25 and the Z-axis motor 38, so that the object 6 placed on the holding sheet 10 is automatically cut.

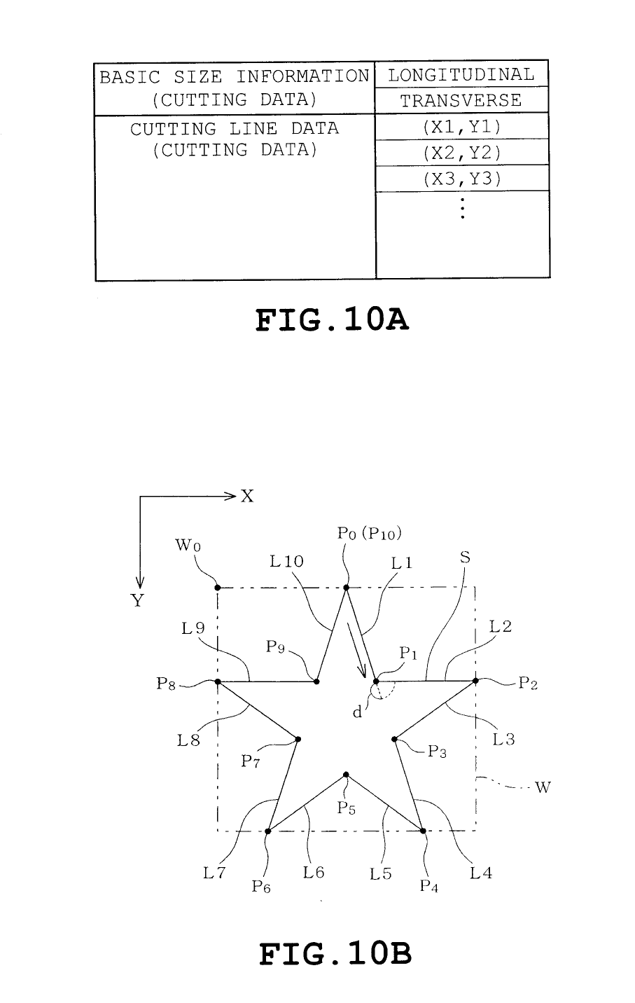

The external memory 64 stores cutting data on which one of a plurality of patterns is cut by the cutting plotter 1. The cutting data contains basic size information, cutting line data and data for display. The basic size information is composed of numeric values indicative of horizontal and vertical dimensions of each pattern and data of imaginary rectangular frame surrounding each pattern. For example, a pattern S of star as shown in FIG. 10B is represented by a size of rectangular frame W surrounding the pattern S while in contact with apexes P₀ to P₁₀ of the pattern S.

The cutting line data is composed of coordinate value data indicative of X-Y coordinates of apexes of the cutting line including a plurality of lines. The cutting line data is specified by the coordinate system of the cutting plotter 1. More specifically, the cutting line of the pattern S includes line segments L1 to L10 as shown in FIG. 10B. The cutting line is formed into a closed star shape with cut start point P₀ and cut end point P₁₀ corresponding with each other. Cutting line data includes first coordinate values (X1, Y1), second coordinate values (X2, Y2), third coordinate values (X3, Y3), . . . , eleventh coordinate values corresponding to a cut start point P₀, apex P1, apex P2, . . . , cut end point P₁₀ respectively. These coordinate values include as a coordinate origin a left upper point W₀ of the rectangular frame W of FIG. 10B, for example. Cutting is executed on the basis of the cutting line data while it is assumed that the coordinate origin corresponds to the origin O of the holding sheet 10.

More specifically, when the cutting plotter 1 cuts the pattern S, the cutter 4 is relatively moved to the X-Y coordinates of the cut start point P₀ of the pattern S by the transfer of the holding sheet 10 (the object 6) in the Y direction by the transfer mechanism 7 and the movement of the cutting head 5 (the cutter 4) in the X direction. Next, the up-down drive mechanism 36 is driven so that the blade edge 4a passes through the cut start point P₀ of the object 6. In this state, the cutter 4 is relatively moved toward the end point P₁ of the line segment L1 by the X-axis motor 15 and the Y-axis motor 25, so that the object 6 is cut along the line segment L1. Regarding the next line segment L2, cutting is continuously executed as the end point P₁ of the previous line segment L1 serving as a start point in the same manner as in the case of line segment L1. Thus, regarding line segments L2 to L10, cutting is sequentially executed continuously, whereby the pattern S, that is, the cutting line of “star” is cut based on the cutting line data.

Furthermore, when the pattern S is cut, the blade edge 4a receives a resistive force from the object 6 with the relative movement of the blade edge 4a. The resistive force will hereinafter be referred to as “cutting resistive force.” The blade edge 4a is offset from the central axis 4z of the cutter 4 by the distance d (see FIG. 8). Accordingly, the cutter 4 is rotated about the central axis 4z. In other words, the direction of the blade edge 4a is automatically changed so as to follow the direction of movement relative to the object 6. For example, the pattern S as shown in FIG. 10B is cut along the line segment 1 in the direction of arrow. In this case, the central axis line 4z is located away from the apex P₁ by distance d on a line extended from the line segment L1. The cutter 4 is then moved so that the central axis line 4z extends along a broken line (arc) in FIG. 10B. As a result, the line segment L2 is cut after the direction of the blade edge 4a has been changed so as to follow the line segment L2.

The cutting head 5 supports the cutter 4 so that the cutter 4 assumes the position displaced in the transfer direction of the object 6 relative to the guide shaft 21 as described above. Accordingly, the cutting resistive force the blade edge 4a receives during cutting applies moment about the guide shaft 21 to the cutter 4 and the cutting head 5. More specifically, when the object 6 is transferred rearward by the transfer mechanism 7, moment is applied to the cutter 4 and the cutting head 5 in the direction of arrow MR as shown in FIG. 3. In other words, when the object 6 is transferred in the Y-axis positive direction, moment is applied in a direction such that the blade edge 4a bites into the object 6 (obliquely downward). On the other hand, when the object 6 is transferred forward or in the Y-axis negative direction, moment is applied in a direction such that the blade edge 4a moves upward (obliquely upward). See arrow MF in FIG. 3. Accordingly, the depth of the blade edge 4a relative to the object 6 slightly differs between the case where the object 6 is transferred in Y-axis positive or negative direction during cutting and the case where only the cutter 4 is moved with the object 6 being stopped. This results from the moment applied to cutter 4 and the cutting head 5. That is, the above-mentioned moment slightly changes flexure of the whole cutter 4 and cutting head 5, a clearance between the sliding contact portion 35 of the cutting head 5 and the pinch roller shaft 13, and the like. When the depth of the blade edge 4a relative to the object 6 slightly differs, there is a possibility that an actually cut line may slightly differ from the cutting line based on the cutting data.

In view of the above-described problem, the cutting plotter 1 of the embodiment is configured to change pressure the cutter 4 applies to the object 6 according to the direction of relative movement between the cutter 4 and the object 6, so that a reliable and high-precision cutting is carried out. More specifically, rotational movement of the Z-axis motor 38 is converted to a vertical movement of the rack member 43 in the up-down drive mechanism 36. An amount of compression of the compression coil spring 53 is changed with the vertical movement of the rack member 43 in the condition where the blade edge 4a is pressed against the object 6. Thus, the biasing force of the compression coil spring 53 and thus the pressure of the cutter 4 can precisely be set by changing the amount of compression of the spring 53 on the basis of an amount of rotation of the Z-axis motor 38.

The ROM 62 stores cutter pressure data about the pressure of the cutter 4 during cutting by the cutting plotter 1. The cutter pressure data is indicative of set values used to control the pressure of the cutter 4 by adjusting the vertical position of the cutter 4 by the drive of the Z-axis motor 38 in the case where the cutter holder 20 assumes the lowered position. Assume now that reference symbol “F” designates a reference value of pressure of the cutter 4 in the cutting plotter 1. In this case, the set value of the pressure of the cutter 4 in the case where the object 6 is transferred in the Y-axis positive direction by the transfer mechanism 7 is referred to as “a first pressure F1” that is smaller than the reference value F. A first pressure F1 is shown by the following equation (1), for example:

F1−F−0.05×F (1)

On the other hand, when the object 6 is transferred in the Y-axis negative direction, the set value of the pressure of the cutter 4 is referred to as “a second pressure F2” that is larger than the reference value F. For example, the second pressure F2 is shown by the following equation (2):

F2=F+0.05×F (2)

Furthermore, the cutter 4 is moved in the right-left direction or in the X direction by the cutter moving mechanism 8 while the transfer of the object 6 by the transfer mechanism 7 has been stopped. In this case, the pressure of the cutter 4 is changed to a third pressure differing from the first and second pressures F1 and F2. The third pressure is the reference value F of the pressure of the cutter 4, for example. Thus, the cutter pressure data is configured as a data table in which the aforementioned relative movement directions correspond to the pressure values F, F1 and F2 respectively. The control circuit 61 is configured to control the Z-axis motor 38 according to the relative movement direction based on the cutter pressure data. Consequently, the pressure the cutter 4 applies to the object 6 is changed to any one of the aforesaid pressure values F, F1 and F2.

The up-down drive mechanism 36 and the control circuit 61 serve as a pressure change unit which changes the pressure the cutter 4 applies to the object 6 according to relative movement of the cutter 4 and the object 6. The Z-axis motor 38, the gear mechanism 36a and the control circuit 61 serve as a biasing force control mechanism which changes the pressure of the cutter 4 by controlling the biasing force of the compression coil spring 53.

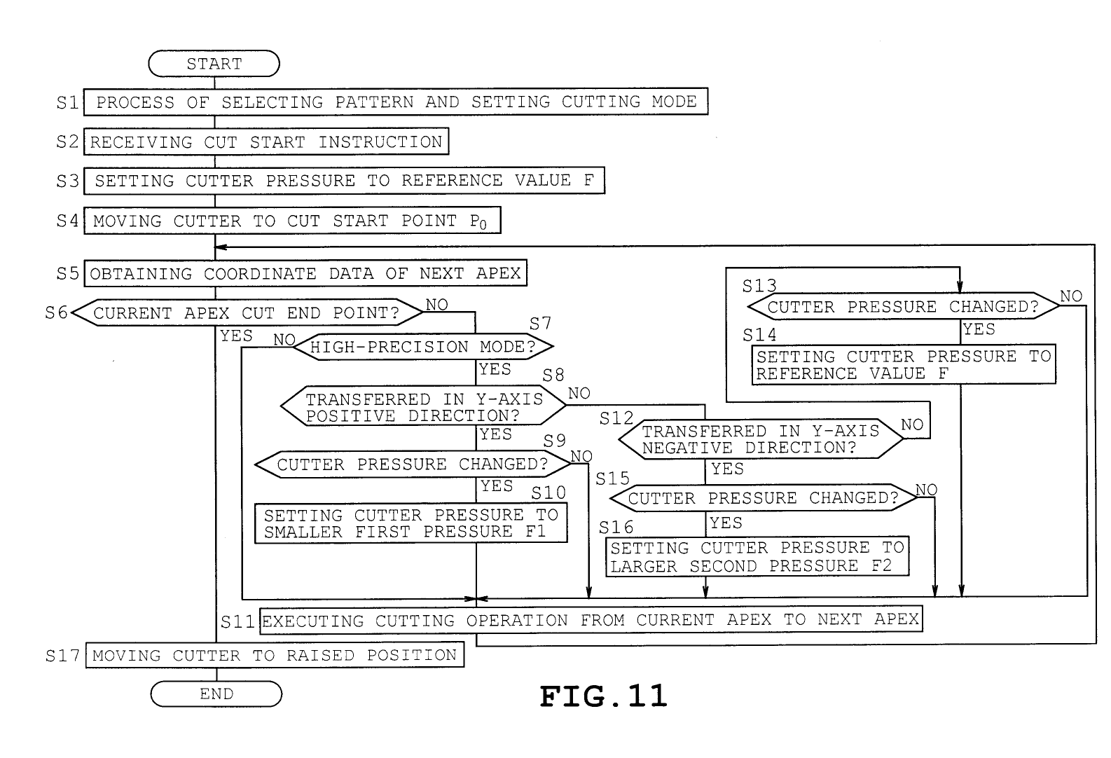

The operation of the above configuration will, now be described with reference to FIG. 11, which is a flowchart showing the processing on a control program executed by the control circuit 61.

In the state of the cutting plotter 1 before the cutting of the object 6 starts, the cutter holder 20 assumes the raised position. In this state, the user sets the holding sheet 10 holding the object 6 from the insertion hole 2a. The user then operates one or more of the switches of the operation device 65 so that the LCD 9 displays a pattern selection screen (not shown) for selecting a pattern and selects a desired pattern (pattern S of star, for example). As a result, the cutting data of the selected pattern S is read from the external memory 64 to be expanded in a memory of the RAM 63.

A mode selection screen (not shown) is displayed on the LCD 9 with respect to the cutting of the pattern S. The mode selection screen includes two selection items, “high-precision mode” and “high speed mode.” The high-precision mode is a first mode in which the pressure of the cutter 4 is changed by the pressure change unit according to the relative movement directions of the cutter 4 and the object 6 during cutting. The high speed mode is a second mode in which the pressure of the cutter 4 is constant during cutting without change. The user selects either mode by operating one of the operation switches of the operation device 65 (step S1).

The user further operates one of the operation switches of the operation device 65 to instruct the cutting plotter 1 to start cutting (step S2). The control circuit 61 starts the cutting operation based on the operation signal. The pressure the cutter 4 applies to the object 6 is set to an initial set pressure (the reference value F of the cutter pressure data, for example) when the cutting operation is to be started (step S3).

The X-axis and Y-axis motors 25 and 15 are then driven in order that the blade edge 4a may be moved to a first coordinate values (X1, Y1) of a cut start point P₀ of the object 6 (see FIGS. 10A and 10B). In this case, the cutter 4 and the object 6 are moved in the X and Y directions relative to each other respectively while being vertically spaced from each other. In the state where the cutter 4 has been moved to the cut start point P₀, the control circuit 61 drives the Z-axis motor 38 to move the cutter holder 20 to the lowered position thereby to cause the blade edge 4a to pass through the cut start point P₀ of the object 6 (step S4). In this case, the control circuit 61 drives the Z-axis motor 38 so that the biasing force of the compression coil spring 53 becomes equal to the reference value F. As a result, the cutter 4 contacts with the object 6 with the pressure of the reference value F.

The control circuit 61 subsequently obtains data of second coordinate values (X2, Y2) indicative of an end point P₁ of the line segment L1 to be initially cut, that is, a next apex P₁ (step S5). In starting the cutting of the line segment L1 (NO at step S6), the control circuit 61 determines whether or not the mode set at step S1 is the high-precision mode (step S7). When the high-precision mode has been set (YES), the control circuit 61 identifies relative movement directions of the cutter 4 and the object 6 in the cutting of the line segment L1.

More specifically, the control circuit 61 calculates the difference (Y2−Y1) between Y2 of the second coordinate values and Y1 of the first coordinate values (step S8). When the obtained value is positive, the control circuit 61 determines that the relative movement directions during the cutting of the line segment L1 include a component of Y-axis positive direction (YES at step S8). That is, assume a pattern having points P₀, P₁, . . . Pᵢ, Pᵢ₊₁ corresponding to respective coordinate values. Further assume that a line segment having a start point P₁ (Xᵢ, Yᵢ) and an end point Pᵢ₊₁ (Xᵢ₊₁, Yᵢ₊₁) is to be cut. In this case, it can be determined whether or not the relative movement directions involved in the cutting of the line segment include a Y-axis positive or negative direction component, depending whether or not the value of difference (Yᵢ₊₁−Yᵢ) between Yᵢ₊₁ and Y₁ is positive or negative.

The control circuit 61 further determines whether or not the current pressure of the cutter 4 is a first pressure F1 corresponding to the Y-axis positive direction as a relative movement direction (step S9). That is, the control circuit 61 determines whether or not the pressure of the cutter 4 is changed, in relation to the current pressure set value F of the cutter 4. As described above, since the relative movement directions pertaining to the cutting of line segment L1 include the Y-axis positive direction, the control circuit 61 determines that the current pressure F of the cutter 4 needs to be changed to the first pressure F1 (YES at step S9). In this case, the control circuit 61 controls the Z-axis motor 38 on the basis of the cutter pressure data so that the biasing force of the compression coil spring 53 becomes F1 smaller than the reference value F (step S10). Consequently, the object 6 is cut from the cut start point P₀ to the end point P₁ of the line segment L1 while the pressure the cutter 4 applies to the object 6 is set at the first pressure F1 (step S11). This can suppress displacement of the blade edge 4a due to the moment MR even when the object 6 is transferred in the Y-axis positive direction during the cutting of line segment L1.

The control circuit 61 obtains data of third coordinate values (X3, Y3) which are to become a next apex P₂ (step S5) after the cutting of the line segment L1 (returning to step S5). In order that the line segment L2 may continuously be cut in the case of the high-precision mode (NO at step S6 and YES at step S7), the control circuit 61 identifies the relative movement directions between the cutter 4 and the object 6 (step S8). In this regard, the line segment L2 is cut by the movement of the cutter 4 in the X direction without transfer of the object 6 in the Y direction (rightward in FIG. 10B). Accordingly, the control circuit 61 determines that the relative movement directions do not include components of Y-axis positive and negative directions based on the difference (Y3−Y2=0) between Y3 of the third coordinate values and Y2 of the second coordinate values (NO at steps S8 and S12).

The pressure of the cutter 4 is currently set at the set value F1. Accordingly, the control circuit 61 determines that the pressure F1 needs to be changed to the third pressure F as the reference value (YES at step S13). In this case, the control circuit 61 controls the Z-axis motor 38 so that the current biasing force F1 of the compression coil spring 53 is returned to the reference value F (step S14). As a result, the cutting can be carried out from a start point P₁ to an end point P₂ of the line segment L2 while the pressure the cutter 4 applies to the object 6 is returned to the normal pressure F (step S11).

Thus, after the cutting of the line segment L2 (returning to step S5), steps S5 to S9 are executed when line segments L3, L4 and L6 each containing the Y-axis positive direction component are to be cut regarding line segment L3 and subsequent line segments. As a result, the cutting is carried out while the pressure of the cutter 4 is set to lust pressure F1 smaller than the reference value F. This suppresses the displacement of the blade edge 4a due to the aforementioned moment MR even when the object 6 is transferred in the Y-axis positive direction during the cutting of line segments L3, L4 and L6. In cutting line segment L4, pressure F1 of the cutter 4 need not be changed in relation to the last cut line segment L3 (NO at step S9).

Steps S5 to S8, S12 and S15 are executed regarding line segments L5, L7, L8 and L10 each containing the Y-axis negative direction component in the same manner as described above. As a result, the cutting is carried out while the pressure of the cutter 4 is set to second pressure F1 larger than the reference value F. This suppresses the displacement of the blade edge 4a due to the aforementioned moment MF even when the object 6 is transferred in the Y-axis negative direction during the cutting of line segments L5, L7, L8 and L10.

Steps S5 to S8, S12 and S13 are carried out regarding, line segment L9 containing only the X direction component in the same manner as the line segment L2. As a result, the cutter 4 can be moved in the X direction to cut the line segment L9 while the pressure the cutter 4 applies to the object 6 is returned to the normal pressure F.

Thus, the control circuit 61 repeatedly executes any one of the above-mentioned groups of steps in the range of steps S5 to S16. Assume now that the control circuit 61 determines at midway step S6 that the current coordinate values of the blade edge 4a are on the cut end point P₁₀ (YES). In this case, the Z-axis motor 38 is driven so that the cutter holder 20 is moved to the raised position. With this, the control circuit 61 causes the cutter 4 to depart from the object 6 (step S17), ending the processing.

The high speed mode is selected instead of the high-precision mode when the object 6 can be cut easier or necessitates not so high level of precision. When the high speed mode is selected at step S1, steps S8 to S10 and S12 to S16 are not executed as the pressure change routine. More specifically, the control circuit 61 determines in the negative at step S7 under the high speed mode. Accordingly, since the control circuit 61 executes steps S5 to S7 and S11 regarding each one of the line segments L1 to L10, the cutting time in the high speed mode can be rendered shorter than in the high-precision mode.

The control circuit 61 constitutes a pressure change unit together with the up-down drive mechanism 36 thereby to execute a pressure change routine of changing the pressure the cutter 4 applies to the object 6, according to the relative movement directions of the cutter 4 and the object 6 respectively (steps S8 to S10 and S12 to S16). According to this configuration, even when the blade edge 4a is subjected to a cutting resistive force from the object 6 during the cutting of the object 6, the pressure of the cutter 4 is changed according to the relative movement direction. This can cope with the displacement of the blade edge 4a resulting from the cutting resistive force during cutting. Accordingly, reliable and high-precision cutting can be realized irrespective of the supporting structure of the cutter 4, a structural clearance and the like.

The pressure change unit changes the pressure of the cutter 4 to first pressure F1 when the object 6 is transferred in one of the transfer directions by the transfer mechanism 7. The pressure change unit changes the pressure of the cutter 4 to second pressure F2 differing from the first pressure F1 when the object 6 is transferred in the other transfer direction. According to this configuration, the pressure of the cutter 4 is changed between the first and second pressures F1 and F2 according to the direction in which the object 6 is transferred by the transfer mechanism 7. This can reliably suppress the displacement of the blade edge 4a in the transfer of the object 6.

The pressure change unit changes the pressure of the cutter 4 to the third pressure F differing from the first and second pressures when the cutter 4 is moved by the cutter moving mechanism 8 in the state where the transfer of the object 6 by the transfer mechanism 7 is stopped. According to this configuration, the pressure of the cutter 4 is changed to the pressures F, F1 and F2 differing between the case where the cutting accompanies the transfer of the object 6 and between the case where the cutting does not accompany the transfer of the object 6. Consequently, the displacement of the blade edge 4a can be suppressed more reliably.

The pressure change unit includes the biasing three control mechanism which changes the pressure of the cutter 4 by controlling the biasing force of the compression coil spring 53 serving as the biasing member. According to this configuration, the pressure of the cutter 4 can be changed by controlling the biasing force of the compression coil spring 53. Furthermore, even when the surface of the object 6 to be cut includes a rugged portion, direct pressure fluctuation in the compression coil spring 4 does not act on the cutter 4 and accordingly, the cutter 4 can be maintained in the pressing state. Accordingly, the change in the pressing state of the cutter 4 during the cutting can be rendered as small as possible and accordingly, higher-precision cutting can be carried out.

The cutter moving mechanism includes the guide member (the guide shaft 21) which extends in the direction intersecting with the transfer direction of the transfer mechanism 7 and is fixed to the machine frame 11. The cutting head 5 serving as the support mechanism is slidably mounted on the guide member and supports the cutter 4 at the position biased in one of transfer directions or in the other transfer direction relative to the guide member. According to this configuration, since the cutter 4 is supported at the position biased in the transfer direction relative to the guide member, an arrangement which does not interrupt replacement of the cutter 4 is realized. Even when the cutting resistive force causes the moment about the guide member to act on the cutter 4 and/or the support mechanism, high-precision cutting can be carried out with the pressure of the cutter 4 according to the relative movement direction.

The cutter 4 is configured to be supported on the support mechanism so that the direction of the blade edge 4a is changed so as to follow the direction of movement relative to the object 6. According to this configuration, the direction of the blade edge 4a corresponds with the relative movement direction. Consequently, the cutting resistive force can be rendered smaller and the relative movement of the cutter 4 can desirably be carried out.

The control circuit 61 in relation to the execution of steps S1 and S7, the LCD 9 and the operation device 65 constitute a mode switching unit which is switchable between the first and second modes when the object 6 is cut. The first mode corresponds to the high-precision mode in which the pressure of the cutter 4 is changed by the pressure change unit. The second mode corresponds to the high speed mode in which the pressure of the cutter 4 is constant without change. According to this configuration, the first mode is selected by the mode switching unit and the pressure of the cutter 4 is changed by the pressure change unit, whereupon the above-described special effects can be achieved. Furthermore, when the second mode is selected by the mode switching unit, the pressure of the cutter 4 is rendered constant without change. Consequently, the cutting time of the object 6 can be shortened since the pressure of the cutter 4 is not changed.

The foregoing embodiment described with reference to the accompanying drawings is not restrictive but may be modified or expanded as follows. The embodiment should not be limited to the cutting plotter but various apparatus with respective cutting functions may be employed. The relative movement directions of the cutter 4 and the object 6 should not be limited to the X and Y directions. For example, even when the transfer direction of the object 6 and the movement direction of the cutter 4 are not orthogonal, the pressure of the cutter 4 may be changed according to the movement directions of the cutter 4 and the object 6. Furthermore, the pressure of the cutter 4 should not be limited to the set values F, F1 and F2 represented by aforementioned equations (1) and (2). For example, the pressure of the cutter 4 may be set according to a spring constant of the compression coil spring 53, the support structure of the cutter 4 and the cutting head 5 or stiffness of the cutter 4 and the cutting head, structural clearance, backlash of each one of the mechanisms 7a, 8a and 36a, or the like.

The mode switching unit may be configured to automatically switch the mode without use of the operation switches of the operation device 65 and the LCD 9 respectively serving as the input unit and the display unit. More specifically, the control circuit 61 may determine, at step S1, the size of the pattern and complexity of the shape of the pattern, based on the cutting data of the selected pattern. The control circuit 61 may be configured to execute switching between the high-precision mode and the high speed mode, based on the result of determination.

The storage medium storing the control program should not be limited to the ROM 62 of the cutting plotter 1. The storage medium may be a CD-ROM, a flexible disc, DVD or a memory card. In this case, when the control program stored by the storage medium is read and executed by a computer of each one of various apparatus with a cutting function, whereby the same effect as described above can be achieved.

The foregoing description and drawings are merely illustrative of the present disclosure and are not to be construed in a limiting sense. Various changes and modifications will become apparent to those of ordinary skill in the art. All such changes and modifications are seen to fall within the scope of the appended claims.

What is claimed is:

1. A cutting apparatus comprising:
a cutter holder configured to receive a cutter;
a transfer mechanism configured to transfer an object to as first direction;
a cutter moving mechanism configured to move the cutter holder to a second direction, the first direction and the second direction are relative to each other;
a pressure control mechanism configured to change a pressure of the cutter holder to the object, based on a pressure value for pressing the cutter holder;
a processor; and
a memory configured to store computer-readable instructions, when executed by the processor, cause the cutting apparatus to:
specify a specific pressure value for pressing the cutter holder by the pressure control mechanism, according to one or more of the first direction and the second direction.

2. The cutting apparatus according to claim 1,
wherein the specifying the specific pressure value comprises specifying a first pressure value for pressing the cutter holder by the pressure control mechanism, when the transfer mechanism transfers the object to the first direction; and
wherein the specifying the specific pressure value comprises specifying a second pressure value for pressing the cutter holder by the pressure control mechanism, when the transfer mechanism transfers the object to an opposite direction of the first direction, the second pressure value is different from the first pressure value.

3. The cutting apparatus according to claim 2,
wherein the specifying the specific pressure value comprises specifying a third pressure value for pressing the cutter holder by the pressure control mechanism, when the transfer mechanism does not transfer the object and the cutter moving mechanism moves the cutting holder to the second direction, the third pressure value is different from the first pressure value and the second pressure value.

4. The cutting apparatus according to claim 1, further comprising:
a second movement mechanism configured to move the cutter holder to a third direction that is departing from the object to closing to the object,
wherein the pressure control mechanism comprises:
a biasing member configured to bias the cutter holder to the object, the biasing member is disposed on the second movement mechanism;
a biasing control mechanism configured to change biasing force by the biasing member, based on the pressure value.

5. The cutting apparatus according to claim 4, further comprising a support mechanism which supports the cutter so that the cutter is movable in directions such that the cutter is pressed against and departs from the object respectively,
wherein the cutter moving mechanism includes a guide member which extends in a direction intersecting with a transfer direction of the transfer mechanism; and
the support mechanism is slidably supported on the guide member and supports the cutter at a location deviated from the guide member in one or the other of the moving directions of the cutter.

6. The cutting apparatus according to claim 4,
wherein the cutter is such that a direction of a blade edge of the cutter is configured to be changed according to one or more of one or more of the first direction and the second direction.

7. The cutting apparatus according to claim 1,
wherein the computer-readable instructions further cause the cutting apparatus to:
receive an instruction for setting a first mode or a second mode, the first mode is allowed to change the pressure of the pressure control mechanism based on the pressure value, and the second mode is not allowed to change the pressure of the pressure control mechanism based on the pressure value; and
set the first mode or the second mode according to the received instruction.

8. The cutting apparatus according to claim 4,
wherein the biasing member is a spring.

9. A non-transitory computer-readable medium storing computer-readable instructions therein that, when executed by a processor of a cutting apparatus, cause the cutting apparatus to:
specify a specific pressure value for pressing a cutter holder of the cutting apparatus, by a pressure control mechanism configured to change a pressure of the cutter holder to an object based on the specific pressure value for pressing the cutter holder, according to one or more of a first direction to which a transfer mechanism configured to transfer the object, and a second direction to which a cutter moving mechanism configured to move the cutter holder, the cutter holder is configured to receive a cutter.

10. The medium according to claim 9,
wherein the specifying the specific pressure value comprises specifying as first pressure value for pressing the cutter holder by the pressure control mechanism, when the transfer mechanism transfers the object to the first direction; and
wherein the specifying the specific pressure value comprises specifying a second pressure value for pressing the cutter holder by the pressure control mechanism, when the transfer mechanism transfers the object to an opposite direction of the first direction, the second pressure value is different from the first pressure value.

11. The medium according to claim 10,
wherein the specifying the specific pressure value comprises specifying a third pressure value for pressing the cutter holder by the pressure control mechanism, when the transfer mechanism does not transfer the object and the cutter moving mechanism moves the cutting holder to the second direction, the third pressure value is different from the first pressure value and the second pressure value.

12. The medium according to claim 9,
wherein the computer-readable instructions further cause the cutting apparatus to:
receive an instruction for setting a first mode or a second mode, the first mode is allowed to change the pressure of the pressure control mechanism based on the pressure value, and the second mode is not allowed to change the pressure of the pressure control mechanism based on the pressure value; and
set the first mode or the second mode according to the received instruction.
